(19) United States
(12) Patent Application Publication
(10) Pub. No.: US 2024/0404322 A1
(43) Pub. Date: Dec. 5, 2024

(54) INFORMATION PROCESSING APPARATUS AND INFORMATION PROCESSING METHOD

(71) Applicant: Sony Group Corporation, Tokyo (JP)

(72) Inventors: Akira Matsui, Kanagawa (JP); Masaya Kinoshita, Kanagawa (JP); Akihiko Utsugi, Kanagawa (JP); Hiroaki Ebi, Kanagawa (JP)

(21) Appl. No.: 18/692,510

(22) PCT Filed: Mar. 17, 2022
(86) PCT No.: PCT/JP22/12459

§ 371 Date: Mar. 15, 2024

(30) Foreign Application Priority Data
Sep. 22, 2021 (JP) 2021-153856

(51) Int. Cl. G06V 40/16; G06T 11/60

(52) U.S. Cl. CPC G06V 40/174; G06T 11/60

(57) ABSTRACT

Information processing that effectively uses emotion data indicating a user emotion for each scene of a moving image content is disclosed. In one example, an extraction unit extracts an emotion representative scene on the basis of emotion metadata having user emotion information for each scene of the moving image content. Reproduction of a part of the moving image content and editing of extracting a part of the moving image content can be effectively performed on the basis of the extracted emotion representative scene. For example, the extraction unit extracts the emotion representative scene on the basis of a type of the user emotion or a degree of the user emotion.

### TECHNICAL FIELD

The present technology relates to an information processing apparatus and an information processing method, and more particularly, to an information processing apparatus and the like that process information regarding a moving image content.

### BACKGROUND ART

In the related art, various technologies for generating emotion data indicating a user emotion for each scene of a moving image content on the basis of a face image of a user, biometric information of the user, or the like have been proposed (see, for example, Patent Document 1).

### CITATION LIST

### Patent Document

Patent Document 1: Japanese Patent Application Laid-Open No. 2020-126645

### SUMMARY OF THE INVENTION

### Problems to be Solved by the Invention

An object of the present technology is to enable effective use of emotion data indicating a user emotion for each scene of a moving image content.

### Solutions to Problems

A concept of the present technology is an information processing apparatus including an extraction unit that extracts an emotion representative scene on the basis of emotion metadata having user emotion information for each scene of moving image content.

In the present technology, the extraction unit extracts the emotion representative scene on the basis of the emotion metadata having user emotion information for each scene of the moving image content. For example, the extraction unit may extract the emotion representative scene on the basis of a type of the user emotion.

Furthermore, for example, the extraction unit may extract the emotion representative scene on the basis of a degree of the user emotion. In this case, for example, the extraction unit may extract, as the emotion representative scene, a scene in which the degree of the user emotion exceeds a threshold. Furthermore, in this case, for example, the extraction unit may extract the emotion representative scene on the basis of a statistical value of the degree of the user emotion of the entire moving image content. Here, the statistical value may include, for example, a maximum value, a sorting result, an average value, or a standard deviation value.

As described above, in the present technology, the emotion representative scene is extracted on the basis of the emotion metadata having the user emotion information for each scene of the moving image content, and the emotion data indicating the user emotion for each scene of the moving image content can be effectively used in reproduction and editing of the moving image content.

Note that, in the present technology, for example, a reproduction control unit that reproduces the extracted emotion representative scene out of the moving image content may be further included. Therefore, the user can view only the extracted emotion representative scene.

Furthermore, in the present technology, for example, an editing control unit that extracts the extracted emotion representative scene out of the moving image content and generates a new moving image content may be further included. Therefore, the user can obtain a new moving image content including only the extracted emotion representative scene.

Furthermore, in the present technology, for example, a display control unit that displays which time position of the extracted emotion representative scene with respect to the entire moving image content may be further included. Therefore, the user can easily recognize which time position of the extracted emotion representative scene with respect to the entire moving image content.

In this case, for example, the display control unit may display a type and a degree of the user emotion in the extracted emotion representative scene at a time position corresponding to the extracted emotion representative scene on a time-axis slide bar corresponding to the entire moving image content. In this case, the user can recognize the time position of the extracted emotion representative scene with respect to the entire image content by the position of the time-axis slide bar, and can easily recognize the type and the degree of the user emotion in the extracted emotion scene.

Here, for example, the display control unit may display the type of the user emotion with a mark. Therefore, the user can intuitively recognize the type of the emotion from the mark.

### BRIEF DESCRIPTION OF DRAWINGS

FIG. 1 is a block diagram illustrating a configuration example of an information processing apparatus that generates emotion metadata.

FIG. 2 is a block diagram illustrating another configuration example of the information processing apparatus that generates the emotion metadata.

FIG. 3 is a block diagram illustrating a configuration example of the information processing apparatus using the emotion metadata.

FIG. 4 is a diagram for describing a case where a scene in which a degree of a user emotion exceeds a threshold is extracted as an emotion representative scene.

FIG. 5 is a diagram for describing a case where the emotion representative scene is extracted on the basis of a statistical value of the degree of user emotion of the entire moving image content.

FIG. 6 is a diagram for describing a display example of displaying which position of the emotion representative scene with respect to the entire moving image content, and the like.

FIG. 7 is a block diagram illustrating another configuration example of the information processing apparatus using the emotion metadata.

### MODE FOR CARRYING OUT THE INVENTION

Hereinafter, a mode for carrying out the invention (hereinafter, referred to as an “embodiment”) will be described. Note that, the description will be given in the following order.
1. Embodiment
2. Variation

### 1. Embodiment

### [Configuration Example of Information Processing Apparatus for Generating Emotion Metadata]

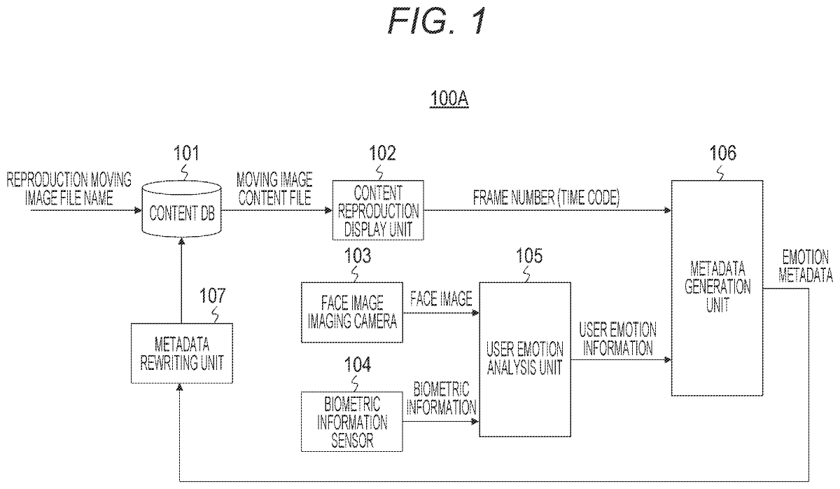

FIG. 1 illustrates a configuration example of an information processing apparatus 100A that generates emotion metadata. The information processing apparatus 100A includes a content database (content DB) 101, a content reproduction display unit 102, a face image imaging camera 103, a biometric information sensor 104, a user emotion analysis unit 105, a metadata generation unit 106, and a metadata rewriting unit 107.

The content database 101 stores a plurality of moving image content files. A reproduction moving image file name is input, and thus, the content database 101 supplies a moving image content file corresponding to the reproduction moving image file name to the content reproduction display unit 102. Here, the reproduction moving image file name is designated by, for example, a user of the information processing apparatus 100A.

During reproduction, the content reproduction display unit 102 reproduces the moving image content included in the moving image content file supplied from the content database 101, and displays a moving image on a display unit (not illustrated). Furthermore, during reproduction, the content reproduction display unit 102 supplies, to the metadata generation unit 106, a frame number (time code) in synchronization with a reproduction frame. The frame number is information that can specify a scene of the moving image content.

The face image imaging camera 103 is a camera that images face images of users who view the moving image displayed on the display unit by the content reproduction display unit 102. Face images of frames imaged by the face image imaging camera 103 are sequentially supplied to the user emotion analysis unit 105.

The biometric information sensor 104 is a sensor for acquiring biometric information such as a heart rate, a respiratory rate, and a perspiration amount, which is attached to the user who views the moving image displayed on the display unit by the content reproduction display unit 102. Pieces of biometric information of frames acquired by the biometric information sensor 104 are sequentially supplied to the user emotion analysis unit 105.

The user emotion analysis unit 105 analyzes a degree of a predetermined type of user emotion for each frame on the basis of the face images of the frames sequentially supplied from the face image imaging camera 103 and the pieces of biometric information of the frames sequentially supplied from the biometric information sensor 104, and supplies user emotion information to the metadata generation unit 106.

Note that, the type of the user emotion is not limited to secondary information obtained by analyzing the face image and the biometric information, for example, information such as “joy”, “anger”, “sorrow”, and “pleasure”, and may be primary information that is the biometric information itself such as a heart rate, a respiratory rate, and a perspiration amount.

The metadata generation unit 106 associates the user emotion information of each frame obtained by the user emotion analysis unit 105 with the frame number (time code), generates emotion metadata having the user emotion information for each frame of the moving image content, and supplies the emotion metadata to the metadata rewriting unit 107.

In a case where the emotion metadata has not yet been added to the moving image content file corresponding to the reproduction moving image file name, the metadata rewriting unit 107 adds the emotion metadata supplied from the metadata generation unit 106 as it is. Furthermore, in a case where the emotion metadata is already added to the moving image content file corresponding to the reproduction moving image file name, the metadata rewriting unit 107 updates the emotion metadata supplied from the metadata generation unit 106.

Alternatively, in a case where the emotion metadata has been already added to the moving image content file corresponding to the reproduction moving image file name, the metadata rewriting unit 107 updates the emotion metadata obtained by combining the emotion metadata supplied from the metadata generation unit 106 with the already added emotion metadata. Although a weighted average is conceivable as a combination method, the present disclosure is not limited thereto, and other methods may be used. Note that, in the case of the weighted average, when the already added emotion metadata relates to m users, the already added emotion metadata and the emotion metadata supplied from the metadata generation unit 106 are weighted by m:1 and averaged.

In a case where the emotion metadata obtained by such combination is updated, as the number of users who view the moving image content increases, the emotion metadata is updated and becomes more accurate emotion metadata, and is useful during reproduction and editing of the moving image content.

As described above, in the information processing apparatus 100A illustrated in FIG. 1, the emotion metadata having the user emotion information for each frame of the moving image content is generated, and the emotion metadata is added to the moving image content file. The emotion metadata can be used in a case where the moving image content is reproduced and viewed or in a case where the moving image content is edited.

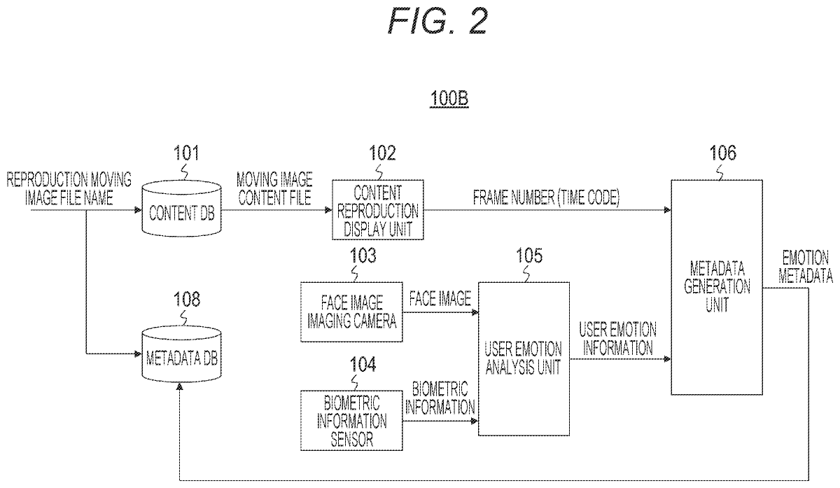

FIG. 2 illustrates a configuration example of an information processing apparatus 100B that generates emotion metadata. In FIG. 2, portions corresponding to the portions in FIG. 1 are denoted by the same reference signs, and detailed description thereof is appropriately omitted.

The information processing apparatus 100B includes a content database (content DB) 101, a content reproduction display unit 102, a face image imaging camera 103, a biometric information sensor 104, a user emotion analysis unit 105, a metadata generation unit 106, and a metadata database (metadata DB) 108.

The metadata generation unit 106 associates user emotion information of each frame obtained by the user emotion analysis unit 105 with a frame number (time code), generates emotion metadata having the user emotion information for each frame of a moving image content, and supplies the emotion metadata to the metadata database 108.

The metadata database 108 stores pieces of emotion metadata corresponding to a plurality of moving image content files. The metadata database 108 stores the emotion metadata supplied from the metadata generation unit 106 together with the moving image file name in the database, that is, in association with the moving image file name such that the emotion metadata can be specified for which moving image content file. In a case where the emotion metadata corresponding to the reproduction moving image file name has not yet been stored, the metadata database 108 stores the emotion metadata supplied from the metadata generation unit 106 as it is. Furthermore, in a case where the emotion metadata corresponding to the reproduction moving image file name has already been stored, the metadata database 108 updates the stored emotion metadata with the emotion metadata supplied from the metadata generation unit 106.

Alternatively, in a case where the emotion metadata corresponding to the reproduction moving image file name has already been stored, the metadata database 108 updates the stored emotion metadata with the emotion metadata obtained by combining the emotion metadata supplied from the metadata generation unit 106 with the already stored emotion metadata. Although detailed description is omitted, a combination method is similar to the case of the metadata rewriting unit 107 in the above-described information processing apparatus 100A of FIG. 1.

Note that, in the illustrated example, the emotion metadata stored in the metadata database 108 and the moving image content file stored in the content database 101 are associated with each other by the moving image file name. However, it is also possible to perform association by using another method, for example, link information such as a URL. In this case, for example, association is performed by recording, as metadata in the corresponding moving image content file of the content database 101, link information such as a URL for accessing the emotion metadata stored in the metadata database 108.

The other configuration of the information processing apparatus 100B illustrated in FIG. 2 is similar to the configuration of the information processing apparatus 100A illustrated in FIG. 1.

As described above, in the information processing apparatus 100B illustrated in FIG. 2, the emotion metadata having the user emotion information for each frame of the moving image content is generated and stored in the metadata database 108 in association with the moving image content file, and the emotion metadata can be used in a case where the moving image content is reproduced and viewed or in a case where the moving image content is edited.

Furthermore, in the information processing apparatus 100B, the pieces of emotion metadata corresponding to the plurality of moving image content files are stored in the metadata database 108. As compared with a case where the emotion metadata is added to the moving image content file stored in the content metadata 101 as illustrated in the information processing apparatus 100A illustrated in FIG. 1, since processing of extracting the emotion metadata from the moving image content file is unnecessary, in particular, in a case where some kind of analysis is performed by using only the emotion metadata, the processing can be performed efficiently.

### [Configuration Example of Information Processing Apparatus Using Emotion Metadata]

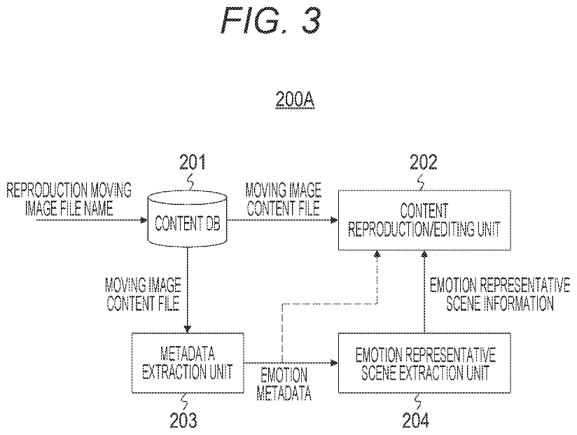

FIG. 3 illustrates a configuration example of an information processing apparatus 200A using emotion metadata. The information processing apparatus 200A includes a content database (content DB) 201, a content reproduction/editing unit 202, a metadata extraction unit 203, and an emotion representative scene extraction unit 204.

The content database 201 corresponds to the content database 101 illustrated in FIG. 1, stores a plurality of moving image content files, and emotion metadata having user emotion information for each frame of a moving image content is added to each moving image content file.

A reproduction moving image file name is input, and thus, the content database 201 supplies the moving image content file corresponding to the reproduction moving image file name to the content reproduction/editing unit 202 and the metadata extraction unit 203. Here, the reproduction moving image file name is designated by, for example, a user of the information processing apparatus 200A.

The metadata extraction unit 203 extracts the emotion metadata from the moving image content file supplied from the content data database 201, and supplies the emotion metadata to the emotion representative scene extraction unit 204. The emotion representative scene extraction unit 204 extracts an emotion representative scene from the emotion metadata supplied from the metadata extraction unit 203.

For example, the emotion representative scene extraction unit 204 extracts the emotion representative scene on the basis of the type of the user emotion. In this case, for example, in a case where the emotion metadata has information of “joy”, “anger”, “sorrow”, and “pleasure” as the user emotion information for each frame of the moving image content, one of these emotions is selected, and a scene of which a degree (level) thereof is equal to or more than a threshold is extracted as the emotion representative scene. Here, the selection of the emotion and the setting of the threshold can be voluntarily performed by, for example, a user operation.

Furthermore, for example, the emotion representative scene extraction unit 204 extracts the emotion representative scene on the basis of the degree of the user emotion. In this case, (1) a case where a scene in which the degree of the user emotion exceeds the threshold is extracted as the emotion representative scene or (2) a case where the scene is extracted as the emotion representative scene on the basis of a statistical value of the degree of the user emotion of the entire moving image content are conceivable.

First, (1) a case where the scene in which the degree of the user emotion exceeds the threshold is extracted as the emotion representative scene will be described. In this case, for example, in a case where the emotion metadata has information of “joy”, “anger”, “sorrow”, and “pleasure” as the user emotion information for each frame of the moving image content, the scene of which the degree (level) thereof is equal to or more than the threshold in each emotion is extracted as the emotion representative scene. Here, the threshold can be voluntarily set by, for example, the user operation.

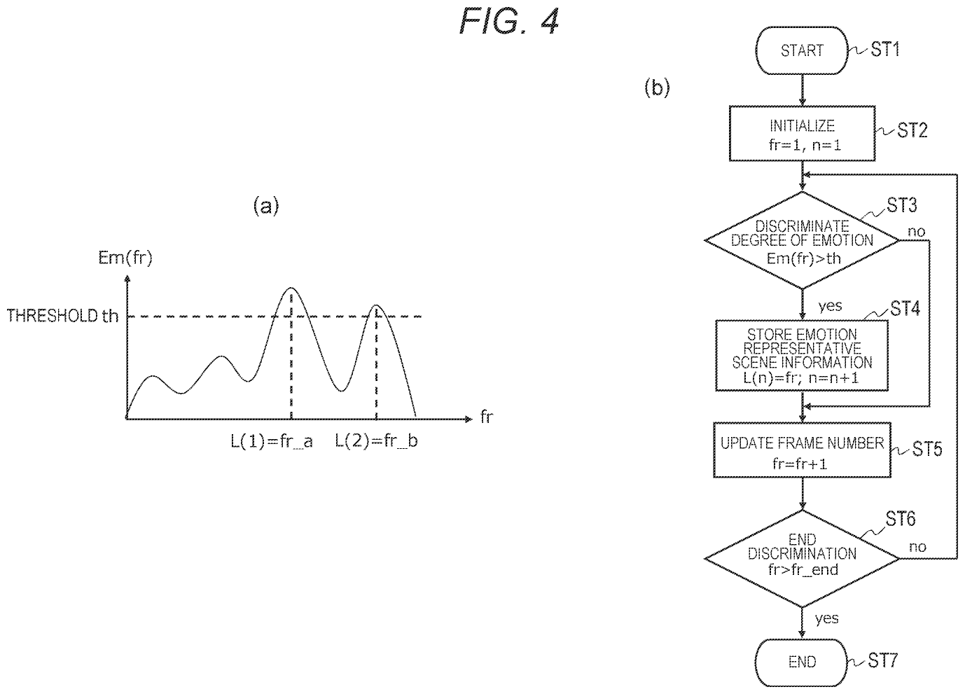

FIG. 4(a) illustrates an example of a change in a degree (level) of a predetermined user emotion for each frame. Here, a horizontal axis represents a frame number fr, and a vertical axis represents a degree Em(fr) of the user emotion. In this example, since a degree Em(fr_a) exceeds a threshold th at a frame number fr_a, the frame number fr_a is stored as emotion representative scene information L(1), and since a degree Em(fr_b) exceeds the threshold th at a frame number fr_b, the frame number fr_b is stored as emotion representative scene information L(2).

A flowchart of FIG. 4(b) illustrates an example of a processing procedure of the emotion representative scene extraction unit 204 in a case where the scene in which the degree of the user emotion exceeds the threshold is extracted as the emotion representative scene.

First, in step ST1, the emotion representative scene extraction unit 204 starts processing. Subsequently, in step ST2, the emotion representative scene extraction unit 204 initializes frame numbers fr=1 and n=1.

Subsequently, in step ST3, the emotion representative scene extraction unit 204 discriminates whether or not the degree Em(fr) is more than the threshold th. When Em(fr)>th is satisfied, the emotion representative scene extraction unit 204 stores the emotion representative scene information, that is, stores the frame number fr as an emotion representative scene L(n) in step ST4. Furthermore, in step ST4, the emotion representative scene extraction unit 204 increments n as n+1.

Subsequently, in step ST5, the emotion representative scene extraction unit 204 updates the frame number fr to fr=fr+1. Similarly, when Em(fr)>th is not satisfied in step ST3, the frame number fr is updated in step ST5.

Subsequently, in step ST6, the emotion representative scene extraction unit 204 discriminates whether or not the frame number fr is more than a last frame number fr_end, that is, performs end discrimination. When fr>fr_end is not satisfied, the emotion representative scene extraction unit 204 returns to the processing of step ST3 and repeats similar processing as described above. On the other hand, when fr>fr_end is satisfied, the emotion representative scene extraction unit 204 ends the processing in step ST7.

Next, (2) a case where the emotion representative scene is extracted on the basis of the statistical value of the degree of the user emotion of the entire moving image content will be described. The statistical value in this case is a maximum value, a sorting result, an average value, a standard deviation value, or the like.

When the statistical value is the maximum value, for example, in a case where the emotion metadata has information of “joy”, “anger”, “sorrow”, and “pleasure” as the user emotion information for each frame of the moving image content, the scene of which the degree (level) thereof is the maximum value in each emotion is extracted as the emotion representative scene.

Furthermore, when the statistical value is the sorting result, for example, in a case where the emotion metadata has information of “joy”, “anger”, “sorrow”, and “pleasure” as the user emotion information for each frame of the moving image content, not only the scene of which the degree (level) thereof is the maximum value but also scenes ranked second and third in the degree (level) thereof in each emotion are extracted as the emotion representative scenes.

Furthermore, when the statistical value is the average value or the standard deviation, for example, in a case where the emotion metadata has information of “joy”, “anger”, “sorrow”, and “pleasure” as the user emotion information for each frame of the moving image content, a scene of which the degree (level) thereof greatly deviates (for example, three times the standard deviation or the like) from an average in each emotion is extracted as the emotion representative scene.

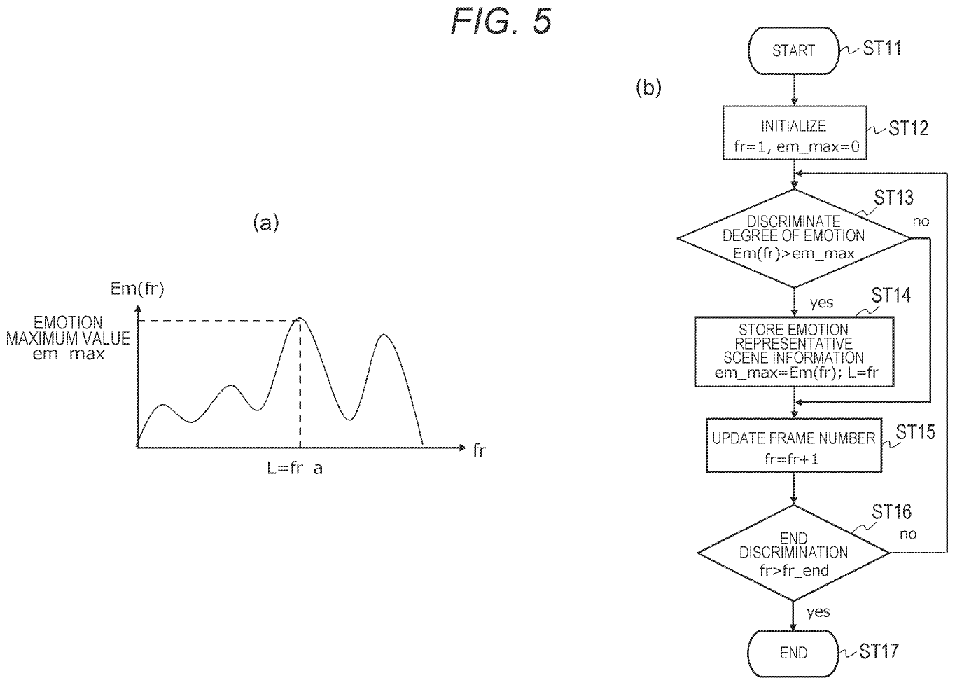

FIG. 5(a) illustrates an example of a change in a predetermined degree (level) of the user emotion for each frame. Here, a horizontal axis represents a frame number fr, and a vertical axis represents a degree Em(fr) of the user emotion. In this example, since a degree Em(fr_a) of a frame number fr_a is a maximum value em_max, the frame number fr_a is stored as emotion representative scene information L.

A flowchart of FIG. 5(b) illustrates an example of a processing procedure of the emotion representative scene extraction unit 204 in a case where the scene of which the degree of the user emotion of the entire moving image content is the maximum value is extracted as the emotion representative scene.

First, in step ST11, the emotion representative scene extraction unit 204 starts processing. Subsequently, in step ST12, the emotion representative scene extraction unit 204 initializes the frame number fr to 1 and the maximum value em_max to 0.

Subsequently, in step ST13, the emotion representative scene extraction unit 204 discriminates whether or not the degree Em(fr) is more than the maximum value em_max. When Em(fr)>em_max is satisfied, the emotion representative scene extraction unit 204 stores the emotion representative scene information, that is, stores the frame number fr as the emotion representative scene L in step ST14. Furthermore, in step ST14, the emotion representative scene extraction unit 204 updates em_max to Em(fr).

Subsequently, in step ST15, the emotion representative scene extraction unit 204 updates the frame number fr to fr=fr+1. When Em(fr)>em_max is not satisfied in step ST13, the frame number fr is similarly updated in step ST15.

Subsequently, in step ST16, the emotion representative scene extraction unit 204 discriminates whether or not the frame number fr is more than a last frame number fr_end, that is, performs end discrimination. When fr>fr_end is not satisfied, the emotion representative scene extraction unit 204 returns to the processing of step ST13 and repeats similar processing as described above. On the other hand, when fr>fr_end is satisfied, the emotion representative scene extraction unit 204 ends the processing in step ST17.

Referring back to FIG. 3, the emotion representative scene extraction unit 204 supplies the emotion representative scene information to the content reproduction/editing unit 202. The content reproduction/editing unit 202 reproduces the moving image content included in the moving image content file supplied from the content database 201.

In this case, the content reproduction/editing unit 202 can reproduce a part of the moving image content included in the moving image content file supplied from the content database 201 in accordance with a user operation or automatically.

In a case where the moving image content is automatically reproduced, for example, a control unit (not illustrated) performs control such that the emotion representative scene extracted by the emotion representative scene information extraction unit 204 is reproduced on the basis of the emotion representative scene information. Therefore, the user can view only the extracted emotion representative scene.

Furthermore, in a case where the moving image content is reproduced in accordance with the user operation, for example, for convenience of the user, the control unit (not illustrated) performs control to display which position of the emotion representative scene extracted by the emotion representative scene information extraction unit 204 with respect to the entire moving image content. Therefore, the user can easily recognize which time position of the extracted emotion representative scene with respect to the entire moving image content, and can efficiently perform a reproduction operation, and for example, can efficiently reproduce only the extracted emotion representative scene.

Furthermore, the content reproduction/editing unit 202 generates a new moving image content by editing the moving image content included in the moving image content file supplied from the content database 201 in accordance with the user operation or automatically.

In a case where the moving image content is automatically edited, for example, a control unit (not illustrated) performs control such that the emotion representative scene extracted by the emotion representative scene information extraction unit 204 is extracted to generate a new moving image content on the basis of the emotion representative scene information. Therefore, it is possible to automatically obtain a new moving image content including only the extracted emotion representative scene.

Furthermore, in a case where the moving image content is edited in accordance with the user operation, for example, for convenience of the user, a control unit (not illustrated) performs control to display which position of the emotion representative scene extracted by the emotion representative scene information extraction unit 204 with respect to the entire moving image content. Therefore, the user can easily recognize which time position of the extracted emotion representative scene with respect to the entire moving image content, and can efficiently perform an editing operation, and for example, can efficiently obtain a new moving image content including only the extracted emotion representative scene.

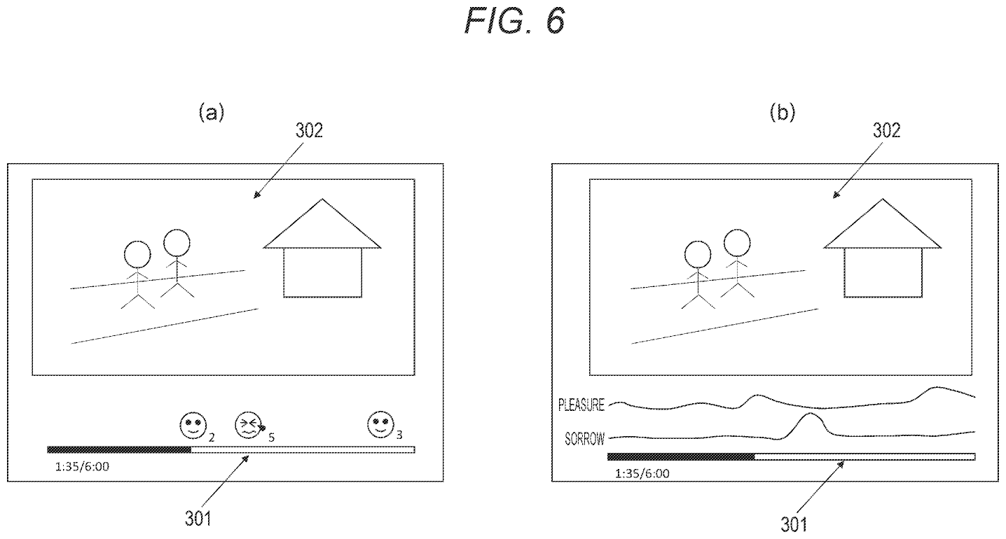

FIG. 6(a) illustrates an example of a case where which position of the emotion representative scene extracted by the emotion representative scene information extraction unit 204 with respect to the entire moving image content is displayed. In this example, a time-axis slide bar 301 indicating the progress of reproduction of the moving image content is displayed at a lower portion, and a reproduction video 302 is displayed at an upper portion.

The time-axis slide bar 301 corresponds to the entire moving image content, and the type and degree of the user emotion in the emotion representative scene is displayed at a time position corresponding to the emotion representative scene extracted by the emotion representative scene information extraction unit 204 on the time-axis slide bar 301. In this case, the user can recognize which time position of the extracted emotion representative scene with respect to the entire moving image content by the position of the time-axis slide bar, and can easily recognize the type and degree of the user emotion in the extracted emotion scene.

In this display example, although the type is indicated by a mark (icon) such that the user can intuitively recognize the type and the degree is indicated by a numerical value, a display mode is not limited thereto.

Note that, instead of displaying the type and degree of the user emotion in the emotion representative scene at the time position corresponding to the emotion representative scene extracted by the emotion representative scene information extraction unit 204, it is conceivable to display the user emotion information for each frame of the moving image content as it is as illustrated in FIG. 6(b). In the illustrated example, only information of “sorrow” and “pleasure” is illustrated for simplification of the drawing. In this case, as indicated by a broken line in FIG. 3, the emotion metadata extracted by the metadata extraction unit 203 is supplied to the content reproduction/editing unit 202, and display is performed on the basis of the emotion metadata.

As described above, in the information processing apparatus 200A illustrated in FIG. 3, the emotion representative scene information extraction unit 204 extracts the emotion representative scene on the basis of the emotion metadata having the user emotion information for each frame of the moving image content, and the emotion data indicating the user emotion for each frame of the moving image content can be effectively used in the reproduction and editing of the moving image content.

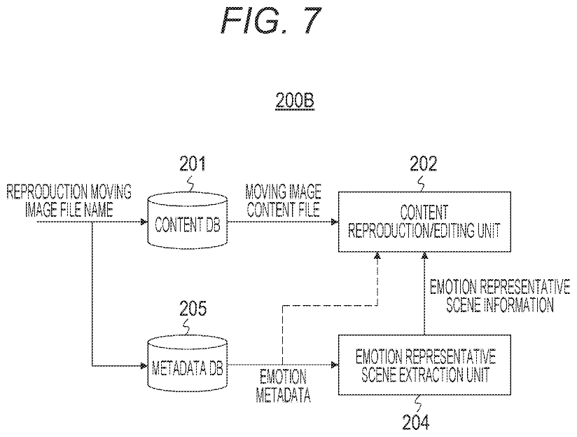

FIG. 7 illustrates a configuration example of an information processing apparatus 200B using emotion metadata. In FIG. 7, portions corresponding to those in FIG. 3 are denoted by the same reference numerals, and detailed description thereof is appropriately omitted.

The information processing apparatus 200B includes a content database (content DB) 201, a content reproduction/editing unit 202, a metadata database (metadata DB) 205, and an emotion representative scene extraction unit 204.

The metadata database 205 corresponds to the metadata database 108 illustrated in FIG. 2, and stores pieces of emotion metadata associated with a plurality of moving image content files stored in the content database 201. Note that, in this example, an example in which association is performed with a moving image file name is illustrated.

The same reproduction moving image file name as the reproduction moving image file name input to the content database 201 is input, and thus, the metadata database 205 supplies, to the emotion representative scene extraction unit 204, the emotion metadata associated with the moving image content file supplied from the content database 201 to the content reproduction/editing unit 202.

The emotion representative scene extraction unit 204 extracts an emotion representative scene from the emotion metadata supplied from the metadata database 205, and supplies the emotion representative scene information to the content reproduction/editing unit 202.

The other configuration of the information processing apparatus 200B illustrated in FIG. 7 is similar to the configuration of the information processing apparatus 200A illustrated in FIG. 3. The information processing apparatus 200B can also obtain effects similar to the effects of the information processing apparatus 200A illustrated in FIG. 3.

### 2. Variation

Note that, in the above-described embodiment, an example in which the emotion metadata has the user emotion information for each frame of the moving image content has been described. That is, an example in which each scene includes one frame has been described. However, a configuration in which the emotion metadata has the user emotion information for a plurality of frames instead of each frame is also conceivable. In this case, each scene includes a plurality of frames. Therefore, it is possible to suppress the data amount of the emotion metadata.

Furthermore, in the above-described embodiment, it has been described that, when the emotion metadata is generated, the emotion metadata with higher accuracy can be obtained by a plurality of users sequentially viewing the moving image content and updating the emotion metadata. However, it is also conceivable to obtain highly accurate emotion metadata at one time by inputting face images and pieces of biometric information regarding a plurality of users to the user emotion analysis unit 105 and performing analysis.

Note that, although the emotion metadata generated by viewing of one user is metadata having the emotion information of the one user, the emotion metadata generated by viewing of a large number of users is metadata having the emotion information statistically representative from emotion responses of other people.

Furthermore, although not described above, it is also conceivable that the emotion metadata is generated for each generation, gender, country, or the like, and can be used for reproduction or editing including a difference between the attributes.

Furthermore, the preferred embodiment of the present disclosure has been described in detail with reference to the accompanying drawings, but the technical scope of the present disclosure is not limited to such example. It is apparent that a person having ordinary knowledge in the technical field of the present disclosure can achieve various variations or modifications within the scope of the technical idea recited in claims, and it will be naturally understood that they also belong to the technical scope of the present disclosure.

Furthermore, the effects described in the present description are merely exemplary or illustrative, and not restrictive. That is, the technology according to the present disclosure may exert other effects apparent to those skilled in the art from the description of the present specification in addition to or instead of the effects described above.

Furthermore, the present technology can also have the following configurations.
(1) An information processing apparatus including
an extraction unit that extracts an emotion representative scene on a basis of emotion data having a user emotion for each scene of a moving image content.
(2) The information processing apparatus according to the above (1), in which
the extraction unit extracts the emotion representative scene on a basis of a type of the user emotion.
(3) The information processing apparatus according to the above (1), in which
the extraction unit extracts the emotion representative scene on a basis of a degree of the user emotion.
(4) The information processing apparatus according to the above (3), in which
the extraction unit extracts, as the emotion representative scene, a scene in which the degree of the user emotion exceeds a threshold.
(5) The information processing apparatus according to the above (3), in which
the extraction unit extracts the emotion representative scene on a basis of a statistical value of the degree of the user emotion of the entire moving image content.
(6) The information processing apparatus according to the above (5), in which
the statistical value includes a maximum value, a sorting result, an average value, or a standard deviation value.
(7) The information processing apparatus according to any one of the above (1) to (6) further including
a reproduction control unit that reproduces the extracted emotion representative scene of the moving image content.
(8) The information processing apparatus according to any one of the above (1) to (7) further including
an editing control unit that extracts the extracted emotion representative scene of the moving image content to generate a new moving image content.
(9) The information processing apparatus according to any one of the above (1) to (8) further including
a display control unit that displays which time position of the extracted emotion representative scene with respect to the entire moving image content.
(10) The information processing apparatus according to the above (9), in which
the display control unit displays a type and a degree of the user emotion in the extracted emotion representative scene at a time position corresponding to the extracted emotion representative scene on a time-axis slide bar corresponding to the entire moving image content.
(11) The information processing apparatus according to the above (10), in which
the display control unit displays the type of the user emotion with a mark.
(12) An information processing method including
a procedure of extracting an emotion representative scene on a basis of emotion data having a user emotion for each scene of a moving image content.

### REFERENCE SIGNS LIST

100A, 100B Information processing apparatus
101 Content database (content DB)
102 Content reproduction display unit
103 Face image imaging camera
104 Biometric information sensor
105 User emotion analysis unit
106 Metadata generation unit
107 Metadata rewriting unit
108 Metadata database (metadata DB)
200A, 200B Information processing apparatus
201 Content database (content DB)
202 Content reproduction/editing unit
203 Metadata extraction unit
204 Emotion representative scene extraction unit
205 Metadata database (metadata DB)

1. An information processing apparatus comprising
an extraction unit that extracts an emotion representative scene on a basis of emotion data having a user emotion for each scene of a moving image content.

2. The information processing apparatus according to claim 1, wherein
the extraction unit extracts the emotion representative scene on a basis of a type of the user emotion.

3. The information processing apparatus according to claim 1, wherein
the extraction unit extracts the emotion representative scene on a basis of a degree of the user emotion.

4. The information processing apparatus according to claim 3, wherein
the extraction unit extracts, as the emotion representative scene, a scene in which the degree of the user emotion exceeds a threshold.

5. The information processing apparatus according to claim 3, wherein
the extraction unit extracts the emotion representative scene on a basis of a statistical value of the degree of the user emotion of the entire moving image content.

6. The information processing apparatus according to claim 5, wherein
the statistical value includes a maximum value, a sorting result, an average value, or a standard deviation value.

7. The information processing apparatus according to claim 1, further comprising
a reproduction control unit that reproduces the extracted emotion representative scene out of the moving image content.

8. The information processing apparatus according to claim 1, further comprising
an editing control unit that extracts the extracted emotion representative scene out of the moving image content to generate a new moving image content.

9. The information processing apparatus according to claim 1, further comprising
a display control unit that displays which time position of the extracted emotion representative scene with respect to the entire moving image content.

10. The information processing apparatus according to claim 9, wherein
the display control unit displays a type and a degree of the user emotion in the extracted emotion representative scene at a time position corresponding to the extracted emotion representative scene on a time-axis slide bar corresponding to the entire moving image content.

11. The information processing apparatus according to claim 10, wherein
the display control unit displays the type of the user emotion with a mark.

12. An information processing method comprising
a procedure of extracting an emotion representative scene on a basis of emotion data having a user emotion for each scene of a moving image content.
